(19) United States
(12) Patent Application Publication
(10) Pub. No.: US 2023/0227257 A1
(43) Pub. Date: Jul. 20, 2023

(54) METHOD AND APPARATUS FOR CONTROLLING WAREHOUSING SYSTEM, GUARD DOOR, AND WAREHOUSING SYSTEM

(71) Applicant: HAI ROBOTICS CO., LTD., Shenzhen (CN)

(72) Inventor: Yifan PENG, Shenzhen (CN)

(21) Appl. No.: 18/189,327

(22) Filed: Mar. 24, 2023

Related U.S. Application Data
(63) Continuation of application No. PCT/CN2021/118867, filed on Sep. 16, 2021.

(30) Foreign Application Priority Data
Sep. 30, 2020 (CN) 202011059499.5

(51) Int. Cl. B65G 1/137; G06Q 10/087

(52) U.S. Cl. CPC B65G 1/1371; G06Q 10/087; B65G 2209/04; B65G 2207/40

(57) ABSTRACT

The present disclosure provides a method and apparatus for controlling a warehousing system, a guard door, and a warehousing system. The method includes: obtaining a door-opening-request signal of a guard door, and determining a target region corresponding to the guard door; determining that a state of a first goods-carrying tool in the target region is a non-operating state; and controlling a state of the guard door to be an open state. The safety of the target region where a user enters is ensured. In addition, the state of the goods-carrying tool in the target region corresponding to the guard door is controlled to be a non-operating state and a goods-carrying tool in a non-target region is kept to operate normally, and therefore, when compared with the related art of stopping all goods-carrying tools, the warehousing efficiency is improved and a hardware loss caused to the goods-carrying tool due to repeated starting and stopping is reduced.

### CROSS-REFERENCE TO RELATED APPLICATIONS

This application is a continuation of International Patent Application No. PCT/CN2021/118867 filed on Sep. 16, 2021, which claims priority to Chinese Patent Application No. CN202011059499.5, filed with the China National Intellectual Property Administration on Sep. 30, 2020 and entitled “METHOD AND APPARATUS FOR CONTROLLING WAREHOUSING SYSTEM, GUARD DOOR, AND WAREHOUSING SYSTEM”, which are incorporated herein by reference in their entirety.

### TECHNICAL FIELD

The present disclosure relates to the field of warehousing system technologies, and in particular, to a method and an apparatus for controlling a warehousing system, a guard door, and a warehousing system.

### BACKGROUND

With the rapid development of the logistics industry, in the warehousing system field, an automated warehousing system is increasingly widely applied, many manually carried warehousing operating lines are replaced by automatic robots. In a modern warehousing system, full automation, high efficiency, and high density become development objectives of warehousing automation. A warehousing system generally includes shelving units and at least one goods-carrying tool, and in order to meet a requirement for carrying goods of the goods-carrying tool, sufficient space generally needs to be reserved between the shelving units, for the goods-carrying tool to carry goods to a shelving unit or take out goods from a shelving unit.

In the related art, when a user needs to enter the warehousing system for inspection or performing other items, all goods-carrying tools in the warehousing system are generally stopped, where the goods-carrying tool may be a robot or a forklift, to prevent a moving goods-carrying tool from causing damage to the user, thereby ensuring the safety of the user.

However, in the related art, when the user enters the warehousing system, all the goods-carrying tools are stopped, which brings a relatively low warehousing efficiency. In addition, the goods-carrying tool is frequently started and stopped repeatedly, as a result, a hardware loss may be caused to the goods-carrying tool.

### SUMMARY

The present disclosure provides a method and apparatus for controlling a warehousing system, a guard door, and a warehousing system. Therefore, when a user enters the warehousing system, the safety of the user is ensured, the warehousing efficiency is improved, and a hardware loss caused to a goods-carrying tool due to repeated starting and stopping is reduced.

According to a first aspect, an embodiment of the present disclosure provides a method for controlling a warehousing system, the method includes:
obtaining a door-opening-request signal of a guard door, and determining a target region corresponding to the guard door, the target region being a partial region in a plurality of regions of the warehousing system;
determining that a state of a first goods-carrying tool in the target region is a non-operating state; and
controlling a state of the guard door to be an open state.

In the embodiments of the present disclosure, when a door-opening-request signal of a guard door is obtained, a target region corresponding to the guard door is determined and a state of a goods-carrying tool in the target region is determined to be a non-operating state, and the guard door is then opened, thereby ensuring the safety of the target region where a user enters. In addition, the state of the goods-carrying tool in the target region corresponding to the guard door is controlled to be a non-operating state and a goods-carrying tool in a non-target region is kept to operate normally, and therefore, when compared with the related art of stopping all goods-carrying tools, the warehousing efficiency is improved and a hardware loss caused to the goods-carrying tool due to repeated starting and stopping is reduced.

In a possible implementation, according to the method for controlling a warehousing system provided in this embodiment of the present disclosure, the determining that a state of a first goods-carrying tool in the target region is a non-operating state includes:
sending, if the first goods-carrying tool exists, an operation-stop instruction to the first goods-carrying tool, to cause the first goods-carrying tool to stop operation; and
detecting the state of the first goods-carrying tool, to determine that the state of the first goods-carrying tool is a non-operating state.

In this embodiment of the present disclosure, when a goods-carrying tool exists in the target region, a control instruction is sent to the goods-carrying tool in the target region to cause the goods-carrying tool to stop operation, and the state of the first goods-carrying tool is detected to determine that the state of the first goods-carrying tool is a non-operating state, thereby further ensuring the safety of the target region.

In a possible implementation, after the detecting the state of the first goods-carrying tool, the method further includes:
pushing first prompt information when the state of the first goods-carrying tool is an operating state, where the first prompt information is configured to prompt a user that the target region is a non-safe region.

In this embodiment of the present disclosure, when a goods-carrying tool in an operating state exists in the target region, the user is prompted that the target region is a non-safe region, so that the user may be prompted to perform safety check on the goods-carrying tool, thereby further ensuring the safety of the user.

In a possible implementation, before the determining that a state of a first goods-carrying tool in the target region is a non-operating state, the method includes:
determining whether the first goods-carrying tool exists.

In this embodiment of the present disclosure, whether a goods-carrying tool exists in the target region is determined, so that when no goods-carrying tool exists in the target region, the state of the guard door may be controlled to be an open state, thereby avoiding control over the goods-carrying tool.

In a possible implementation, after the determining a target region corresponding to the guard door, the method further includes:
dispatching the first goods-carrying tool to another region other than the target region in the warehousing system.

In this embodiment of the present disclosure, after the target region is determined, a goods-carrying tool in the target region is dispatched to a non-target region, so that the utilization of the goods-carrying tool is improved, and the warehousing efficiency is further improved.

In a possible implementation, the dispatching the first goods-carrying tool to another region other than the target region in the warehousing system includes:
stopping a first task of the first goods-carrying tool, a target shelving unit of the first task is in the target region, and/or controlling the first goods-carrying tool to execute a second task, a target shelving unit of the second task is in another region other than the target region in the warehousing system.

In a possible implementation, the method for controlling a warehousing system provided in this embodiment of the present disclosure further includes:
controlling to forbid a second goods-carrying tool in the warehousing system from entering the target region, where the second goods-carrying tool is a goods-carrying tool in another region other than the target region.

In a possible implementation, the controlling to forbid a second goods-carrying tool in the warehousing system from entering the target region includes:
stopping a first task of the second goods-carrying tool; and/or stopping distributing the first task to the second goods-carrying tool, where a target shelving unit of the first task is in the target region.

A goods-carrying tool in a non-target region is controlled to be forbidden from entering the target region, thereby further ensuring the safety of the target region.

In a possible implementation, the guard door corresponds to a plurality of target regions, and after the determining a target region corresponding to the guard door, the method further includes:
obtaining location information of the user to determine a target region corresponding to the location information; and
the determining that a state of a goods-carrying tool in the target region is a non-operating state includes:
determining that a state of a goods-carrying tool in the target region corresponding to the location information is a non-operating state.

In this embodiment of the present disclosure, when the guard door corresponds to a plurality of target regions, the safety of the target region in which the user is located is ensured.

In a possible implementation, the obtaining location information of the user includes:
detecting a tag of the user, where the tag has a positioning identification function; and
parsing the tag to obtain the location information of the user.

In a possible implementation, after the determining that a state of a goods-carrying tool in the target region is a non-operating state, the method further includes:
displaying a safety identifier in the target region, where the safety identifier is configured to indicate that the target region is a safe region.

In a possible implementation, the safety identifier is a ground identifier.

In a possible implementation, the method for controlling a warehousing system provided in this embodiment of the present disclosure further includes:
sending second prompt information to the user, where the second prompt information is configured to prompt the user that the target region is a safe region.

In a possible implementation, the method for controlling a warehousing system provided in this embodiment of the present disclosure further includes:
restoring the state of the first goods-carrying tool to an operating state if the state of the guard door is determined as a closed state and/or no user is in the target region.

In a possible implementation, the restoring the state of the first goods-carrying tool to an operating state includes:
starting a first task of the first goods-carrying tool, and/or distributing the first task to the first goods-carrying tool, where a target shelving unit of the first task is in the target region.

In a possible implementation, the first goods-carrying tool is a robot or a forklift.

The following describes an apparatus, a guard door, a warehousing system, a computer-readable storage medium, and a computer program product provided in the embodiments of the present disclosure, and for content and effects thereof, reference may be made to the method for controlling a warehousing system provided in the embodiments of the present disclosure, which are not described herein again.

According to a second aspect, an embodiment of the present disclosure provides an apparatus for controlling a warehousing system, including:
an obtaining module, configured to obtain a door-opening-request signal of a guard door, and determine a target region corresponding to the guard door, the target region being a partial region in a plurality of regions of the warehousing system; a determining module, configured to determine that a state of a first goods-carrying tool in the target region is a non-operating state; and a control module, configured to control a state of the guard door to be an open state.

In a possible implementation, the apparatus includes:
a judgment module, configured to determine whether the first goods-carrying tool exists.

In a possible implementation, according to the apparatus for controlling a warehousing system provided in this embodiment of the present disclosure, the determining module is further configured to:
send an operation-stop instruction to the first goods-carrying tool, to cause the first goods-carrying tool to stop operation; and detect the state of the first goods-carrying tool, to determine that the state of the first goods-carrying tool is a non-operating state.

In a possible implementation, the apparatus for controlling a warehousing system provided in this embodiment of the present disclosure further includes:
a pushing module, configured to push first prompt information if the state of the first goods-carrying tool is an operating state, where the first prompt information is configured to prompt a user that the target region is a non-safe region.

In a possible implementation, the control module is further configured to:
dispatch the first goods-carrying tool to another region other than the target region in the warehousing system.

In a possible implementation, the control module is specifically configured to:
stop a first task of the first goods-carrying tool, a target shelving unit of the first task is in the target region, and/or control the first goods-carrying tool to execute a second task, a target shelving unit of the second task is in another region other than the target region in the warehousing system.

In a possible implementation, according to the apparatus for controlling a warehousing system provided in this embodiment of the present disclosure, the control module is further configured to:
control to forbid a second goods-carrying tool in the warehousing system from entering the target region, where the second goods-carrying tool is a goods-carrying tool in another region other than the target region.

In a possible implementation, the control module is specifically configured to:
stop a first task of the second goods-carrying tool; and/or stop distributing the first task to the second goods-carrying tool, where a target shelving unit of the first task is in the target region.

In a possible implementation, the obtaining module is further configured to obtain location information of the user to determine a target region corresponding to the location information; and
the determining module is specifically configured to determine that a state of a goods-carrying tool in the target region corresponding to the location information is a non-operating state.

In a possible implementation, the obtaining module is specifically configured to:
detect a tag of the user, where the tag has a positioning identification function; and parse the tag to obtain the location information of the user.

In a possible implementation, the apparatus for controlling a warehousing system provided in this embodiment of the present disclosure further includes:
a display module, configured to display a safety identifier in the target region, where the safety identifier is configured to indicate that the target region is a safe region.

In a possible implementation, the safety identifier is a ground identifier.

In a possible implementation, the apparatus for controlling a warehousing system provided in this embodiment of the present disclosure further includes:
a transmission module, configured to send second prompt information to the user, where the second prompt information is configured to prompt the user that the target region is a safe region.

In a possible implementation, according to the apparatus for controlling a warehousing system provided in this embodiment of the present disclosure, the control module is further configured to:
restore the state of the first goods-carrying tool to an operating state if the state of the guard door is determined as a closed state and/or no user is in the target region.

In a possible implementation, the control module is specifically configured to:
start a first task of the first goods-carrying tool, and/or distribute the first task to the first goods-carrying tool, where a target shelving unit of the first task is in the target region.

In a possible implementation, the first goods-carrying tool is a robot or a forklift.

According to a third aspect, an embodiment of the present disclosure provides a guard door, including:
at least one processor, and
a memory communicatively connected to the at least one processor, where
the memory stores instructions executable by the at least one processor, and the instructions, when executed by the at least one processor, are configured to perform the method according to the first aspect or the implementations of the first aspect.

According to a fourth aspect, an embodiment of the present disclosure provides a warehousing system, including the guard door provided in the third aspect and a goods-carrying tool.

According to a fifth aspect, an embodiment of the present disclosure provides a non-transitory computer-readable storage medium storing computer instructions, and the computer instructions are executable by a computer, wherein the computer instructions, when being executed by the computer, are configured to perform the method according to the first aspect or the implementations of the first aspect.

According to a sixth aspect, an embodiment of the present disclosure provides a computer program product, including executable instructions, the executable instructions being configured to implement the method according to the first aspect or the implementations of the first aspect.

According to the method and apparatus for controlling a warehousing system, the guard door, and the warehousing system provided in the present disclosure, a door-opening-request signal of a guard door is obtained, and a target region corresponding to the guard door is determined; a state of a first goods-carrying tool in the target region is then determined as a non-operating state; and a state of the guard door is finally controlled to be an open state. In the embodiments of the present disclosure, when a door-opening-request signal of a guard door is obtained, a target region corresponding to the guard door is determined and a state of a goods-carrying tool in the target region is determined to be a non-operating state, and the guard door is then opened, thereby ensuring the safety of the target region where a user enters. In addition, the state of the goods-carrying tool in the target region corresponding to the guard door is controlled to be a non-operating state and a goods-carrying tool in a non-target region is kept to operate normally, and therefore, when compared with the related art of stopping all goods-carrying tools, the warehousing efficiency is improved and a hardware loss caused to the goods-carrying tool due to repeated starting and stopping is reduced.

### BRIEF DESCRIPTION OF THE DRAWINGS

To describe the technical solutions in the embodiments of the present application or in the prior art more clearly, the following briefly introduces the accompanying drawings required for describing the embodiments or the prior art. Apparently, the accompanying drawings in the following description show some embodiments of the present application, and a person of ordinary skill in the art may still derive other drawings from these accompanying drawings without creative efforts.

FIG. 1 is an architecture diagram of an exemplary application scenario according to an embodiment of the present disclosure;

FIG. 2 is a schematic flowchart of a method for controlling a warehousing system according to an embodiment of the present disclosure;

FIG. 3 is a schematic flowchart of a method for controlling a warehousing system according to another embodiment of the present disclosure;

FIG. 4 is a schematic flowchart of a method for controlling a warehousing system according to still another embodiment of the present disclosure;

FIG. 5 is a schematic flowchart of a method for controlling a warehousing system according to yet another embodiment of the present disclosure;

FIG. 6 is a schematic structural diagram of a warehousing system according to an embodiment of the present disclosure;

FIG. 7 is a schematic flowchart of a method for controlling a warehousing system according to yet another embodiment of the present disclosure;

FIG. 8 is a schematic structural diagram of a target region according to an embodiment of the present disclosure;

FIG. 9 is a schematic structural diagram of an apparatus for controlling a warehousing system according to an embodiment of the present disclosure; and

FIG. 10 is a schematic structural diagram of an electronic device according to an embodiment of the present disclosure.

### DETAILED DESCRIPTION

In order to make the objectives, technical solutions, and advantages of the embodiments of the present disclosure clearer, the technical solutions in the embodiments of the present disclosure will be clearly and completely described with reference to the accompanying drawings in the embodiments of the present disclosure. Apparently, the described embodiments are a part of the embodiments of the present disclosure, but not all the embodiments. Based on the embodiments in the present disclosure, all other embodiments obtained by a person of ordinary skill in the art without creative efforts all fall within the protection scope of the present disclosure.

In the specification, claims, and accompanying drawings of the present disclosure, the terms “first”, “second”, “third”, “fourth”, and so on (if existing) are intended to distinguish between similar objects rather than describe a specific order or sequence. It should be understood that the data used in such a way are interchangeable in proper circumstances, so that the embodiments of the present disclosure described herein can be implemented in orders except the order illustrated or described herein. Moreover, the terms “include”, “contain” and any other variants mean to cover the non-exclusive inclusion, for example, a process, method, system, product, or device that includes a list of steps or units is not necessarily limited to those expressly listed steps or units, but may include other steps or units not expressly listed or inherent to such a process, method, system, product, or device.

With the rapid development of the logistics industry, in the warehousing system field, shelving units and at least one goods-carrying tool are generally included. In the related art, when a user needs to enter a warehousing system for inspection or performing other items, all goods-carrying tools in the warehousing system are generally stopped, where the goods-carrying tool may be a robot or a forklift, to prevent a moving goods-carrying tool from causing damage to the user, thereby ensuring the safety of the user. However, in the related art, when the user enters the warehousing system, all the goods-carrying tools are stopped, which brings a relatively low warehousing efficiency. In addition, the goods-carrying tool is frequently started and stopped repeatedly, as a result, a hardware loss may be caused to the goods-carrying tool.

An inventive concept of a method and apparatus for controlling a warehousing system, a guard door, and a warehousing system provided in the embodiments of the present disclosure, a warehousing region of the warehousing system is divided into a plurality of regions, each region has a corresponding guard door, when a door-opening-request signal of a guard door is obtained, a target region corresponding to the guard door is determined, and a state of a goods-carrying tool in the target region is controlled to be a non-operating state, thereby ensuring the safety of the target region. In addition, the state of the goods-carrying tool in the target region is controlled to be a non-operating state and a goods-carrying tool in a non-target region is kept to operate normally, and therefore, when compared with the related art of stopping all goods-carrying tools, the warehousing efficiency is improved and a hardware loss caused to the goods-carrying tool due to repeated starting and stopping is reduced.

The following describes exemplary application scenarios of the embodiments of the present disclosure.

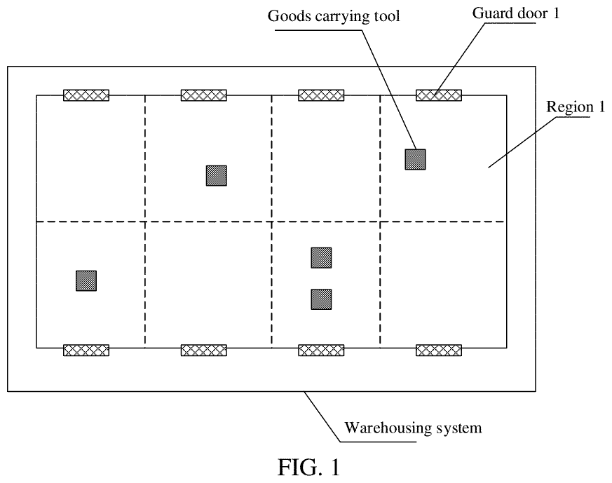

The method for controlling a warehousing system provided in the embodiments of the present disclosure may be executed by the apparatus for controlling a warehousing system provided in the embodiments of the present disclosure. The apparatus for controlling a warehousing system provided in the embodiments of the present disclosure may be integrated on a terminal device or the apparatus for controlling a warehousing system may be a terminal device, and a specific type of the terminal is not limited in the embodiments of the present disclosure. For example, the terminal device may be a guard door, a goods-carrying tool, a smartphone, a personal computer, a tablet computer, a wearable device, an on-board terminal, a surveillance device, a camera, or the like. FIG. 1 is an architecture diagram of an exemplary application scenario according to an embodiment of the present disclosure, and the embodiments of the present disclosure may be applicable to a warehousing system. The warehousing system may include one or more warehousing regions, and each warehousing region may include a plurality of regions. As shown in FIG. 1, the warehousing system includes a warehousing area, the warehousing area includes 8 regions, and each region has a corresponding guard door. For example, a region 1 corresponds to a guard door 1, and a user may directly enter the region 1 through the guard door 1. Goods-carrying tools move in the regions to implement storage and delivery of goods, and in different time periods, the number of goods-carrying tools in each region is not fixed, for example, may be zero or may be one or more goods-carrying tools. A guardrail or a virtual wall may exist between regions to distinguish different regions. The embodiments of the present disclosure only use this application scenario as an example and are not limited thereto.

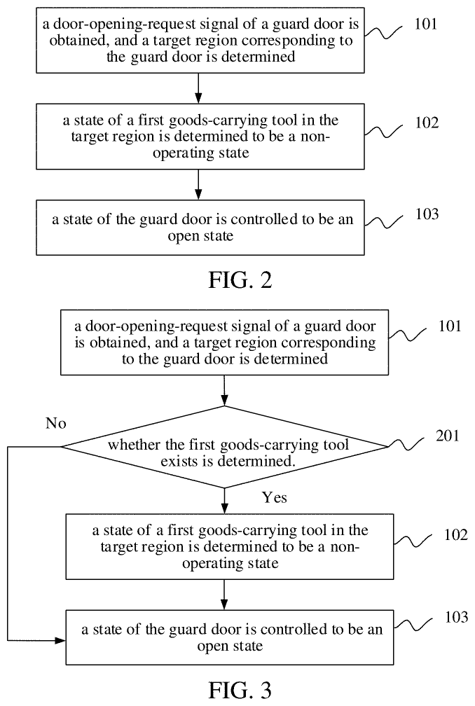

FIG. 2 is a schematic flowchart of a method for controlling a warehousing system according to an embodiment of the present disclosure, the method may be executed by an apparatus for controlling a warehousing system, and the apparatus may be implemented through software and/or hardware. The following describes the method for controlling a warehousing system by using a terminal device as an execution entity. As shown in FIG. 2, the method for controlling a warehousing system according to this embodiment of the present disclosure may include the following operations:

In block S101: a door-opening-request signal of a guard door is obtained, and a target region corresponding to the guard door is determined.

A control manner of the guard door is not limited in the embodiments of the present disclosure. For example, the user may request to open the guard door through face recognition, fingerprint recognition, inputting a keyword, or opening a control button. After a user operation is received, the guard door generates a door-opening-request signal. Information carried in the door-opening-request signal is not limited in the embodiments of the present disclosure, and for example, the door-opening-request signal may carry an identifier of the guard door or a user identifier. After the door-opening-request signal of the guard door is obtained, a target region corresponding to the guard door is determined. There is a correspondence between guard doors and regions of a warehousing region. In a possible implementation, an association list between guard doors and regions may be established, and the target region corresponding to the guard door may be determined by querying the association list, where the target region is a partial region in a plurality of regions of the warehousing system. The embodiments of the present disclosure only use this manner as an example and are not limited thereto.

In block S102: a state of a first goods-carrying tool in the target region is determined to be a non-operating state.

The first goods-carrying tool is a goods-carrying tool in the target region. The non-operating state of the first goods-carrying tool may include a turn-off state or a standby state. In the non-operating state, the first goods-carrying tool cannot move or perform a goods delivery/storage action, thereby preventing movement of the first goods-carrying tool from colliding with and hurting the user.

In a possible implementation, to determine the state of the first goods-carrying tool, the first goods-carrying tool in the target region may be first determined, and the state of the first goods-carrying tool is then detected. If the state of the first goods-carrying tool is an operating state, the state of the first goods-carrying tool is controlled to be a non-operating state, to ensure that the state of the first goods-carrying tool in the target region is the non-operating state.

In a possible implementation, the determining that a state of a first goods-carrying tool in the target region is a non-operating state includes:
sending, if the first goods-carrying tool exists, an operation-stop instruction to the first goods-carrying tool, to cause the first goods-carrying tool to stop operation; and detecting the state of the first goods-carrying tool, to determine that the state of the first goods-carrying tool is the non-operating state.

The terminal device may perform data communication with the first goods-carrying tool, and a specific implementation of the data communication performed between the terminal and the first goods-carrying tool is not limited in the embodiments of the present disclosure. The terminal device may send an operation-stop instruction to the first goods-carrying tool, to cause the first goods-carrying tool to stop operation. The operation-stop instruction may be configured to instruct the first goods-carrying tool to stop operation, or instruct the first goods-carrying tool to enter a standby state, or instruct the first goods-carrying tool to turn off a power supply, which is not limited in the embodiments of the present disclosure.

In this embodiment of the present disclosure, when a goods-carrying tool exists in the target region, a control instruction is transmitted to the goods-carrying tool in the target region to cause the goods-carrying tool to stop operation, and the state of the first goods-carrying tool is detected to determine that the state of the first goods-carrying tool is the non-operating state, thereby further ensuring the safety of the target region.

In a possible implementation, after the detecting the state of the first goods-carrying tool, the method further includes:
pushing first prompt information if the state of the first goods-carrying tool is an operating state, where the first prompt information is configured to prompt a user that the target region is a non-safe region.

After the state of the first goods-carrying tool is detected, the state of the first goods-carrying tool may be an operating state. In this case, due to failure of the first goods-carrying tool, the terminal device cannot perform data communication with the first goods-carrying tool, or the first goods-carrying tool cannot perform an operation notification instruction transmitted by the terminal device, the state of the first goods-carrying tool is an operating state.

In this embodiment of the present disclosure, when there is a goods-carrying tool in an operating state in the target region, the user is prompted that the target region is a non-safe region by pushing the first prompt information, so that the user may be prompted to perform safety check on the goods-carrying tool, thereby further ensuring the safety of the user. A specific implementation for pushing the first prompt information is not limited in the embodiments of the present disclosure. In a possible implementation, prompt information may be pushed through the terminal device, to cause an interface of the terminal device to display the prompt information. In another possible implementation, the first prompt information may be also pushed to a communication address of an administrator of the warehousing system through the terminal device, for example, the first prompt information is pushed to a device such as a mobile phone or a computer of the administrator of the warehousing system. The embodiments of the present disclosure only use this manner as an example and are not limited thereto.

In block S103: a state of the guard door is controlled to be an open state.

After determining that the state of the first goods-carrying tool in the target region is a non-operating state, the state of the guard door is controlled to be an open state. For example, a control signal may be transmitted to the guard door, and the control signal is configured to instruct to open the guard door, which is not limited in the embodiments of the present disclosure.

When the state of the guard door is controlled to be an open state, the user enters the target region through the guard door, to perform inspection or another operation in the target region. After the user completes a task, the user leaves the target region through the guard door and closes the guard door. Based on the foregoing scenario, in a possible implementation, the method for controlling a warehousing system provided in this embodiment of the present disclosure further includes:
restoring the state of the first goods-carrying tool to an operating state if the state of the guard door is determined as a closed state and/or no user is in the target region.

A manner for determining the state of the guard door and a manner for determining whether a user is in the target region are not limited in the embodiments of the present disclosure. For example, the state of the guard door may be determined by detecting the state information of the guard door. In another example, an infrared detection apparatus may be arranged at a location of the guard door, and when the number of users entering the guard door and the number of users exiting the guard door are consistent, it is determined that no user is in the target region. The embodiments of the present disclosure only use the manner as an example.

After determining that the state of the guard door is a closed state, or determining that no user is in the target region, or determining that the state of the guard door is a closed state and no user is in the target region, the state of the first goods-carrying tool is restored to the operating state. The restoring the state of the first goods-carrying tool to the operating state may include controlling the first goods-carrying tool to keep operating or controlling the first goods-carrying tool to be started. In a possible implementation, the restoring the state of the first goods-carrying tool to an operating state includes: starting a first task of the first goods-carrying tool, and/or distributing the first task to the first goods-carrying tool, where a target shelving unit of the first task is in the target region.

The first task of the first goods-carrying tool is started to cause the first goods-carrying tool to execute the first task in the target region. Alternatively, the first task may be also distributed to the first goods-carrying tool to cause the first goods-carrying tool to execute the first task in the target region, where a goods-carrying tool may store and deliver goods in the target region.

In the embodiments of the present disclosure, when a door-opening-request signal of a guard door is obtained, a target region corresponding to the guard door is determined and a state of a goods-carrying tool in the target region is determined to be a non-operating state, and the guard door is then opened, thereby ensuring the safety of the target region where a user enters. In addition, the state of the goods-carrying tool in the target region corresponding to the guard door is controlled to be a non-operating state and a goods-carrying tool in a non-target region is kept to operate normally, and therefore, when compared with the related art of stopping all goods-carrying tools, the warehousing efficiency is improved and a hardware loss caused to the goods-carrying tool due to repeated starting and stopping is reduced.

Based on the foregoing embodiments, in an operation process, the goods-carrying tool may move in different regions of the warehousing system, so that when the user needs to enter a region, no goods-carrying tool may exist in the region. Based on this, in a possible implementation, FIG. 3 is a schematic flowchart of a method for controlling a warehousing system according to another embodiment of the present disclosure. As shown in FIG. 3, in the method for controlling a warehousing system provided in this embodiment of the present disclosure, before S102 of determining that a state of a first goods-carrying tool in the target region is a non-operating state, the method further includes the following operations:

In block S201: whether the first goods-carrying tool exists is determined.

If the first goods-carrying tool does not exist, operation in the block S103 of controlling a state of the guard door to be an open state is performed, and if the first goods-carrying tool exists, operation in the block S102 and block S103 are performed.

To determine whether a goods-carrying tool exists in the target region, location information of goods-carrying tools in a warehousing space may be obtained, and whether a goods-carrying tool exists in the target region among the goods-carrying tools is then determined by using the location information of the goods-carrying tools. If there is a goods-carrying tool in the target region, it is determined that the first goods-carrying tool exists; and if there is no goods-carrying tool in the target region, it is determined that the first goods-carrying tool does not exist. The embodiments of the present disclosure only use this manner as an example and are not limited thereto.

In this embodiment of the present disclosure, whether there is a goods-carrying tool in the target region is determined, so that when no goods-carrying tool exists in the target region, the state of the guard door is controlled to be an open state, thereby avoiding further control over the goods-carrying tool.

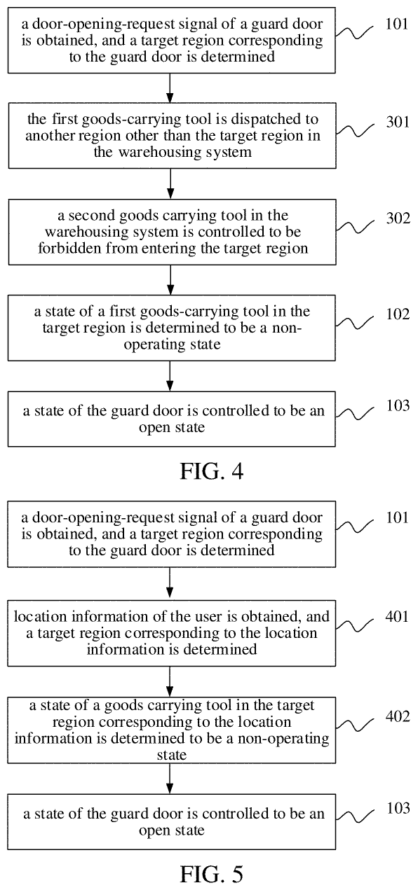

Based on the embodiments shown in FIG. 2 and FIG. 3, in a possible implementation, FIG. 4 is a schematic flowchart of a method for controlling a warehousing system according to another embodiment of the present disclosure. As shown in FIG. 4, in the method for controlling a warehousing system provided in this embodiment of the present disclosure, after the operation in block S101 of determining a target region corresponding to the guard door, the method further includes the following operations:

In block S301: the first goods-carrying tool is dispatched to another region other than the target region in the warehousing system.

If the states of the first goods-carrying tools in the target region are all set to a non-operating state, the goods storage and delivery efficiency of the warehousing system may be affected. To further improve the utilization of the first goods-carrying tool and improve the goods storage and delivery efficiency of the warehousing system, the first goods-carrying tool may be dispatched to another region other than the target region in the warehousing system, namely, a non-target region. A specific implementation of dispatching the first goods-carrying tool to a non-target region is not limited in the embodiments of the present disclosure. For example, the first goods-carrying tool may be controlled to move to a non-target region.

In a possible implementation, the dispatching the first goods-carrying tool to another region other than the target region in the warehousing system includes:
stopping a first task of the first goods-carrying tool, a target shelving unit of the first task is in the target region, and/or controlling the first goods-carrying tool to execute a second task, a target shelving unit of the second task is in another region other than the target region in the

The first goods-carrying tool may need to execute a plurality of tasks, where the plurality of tasks may include one or more first tasks and one or more second tasks. In a possible implementation, by stopping the first task of the first goods-carrying tool, the first goods-carrying tool may execute the second task according to a task sequence. Since the target shelving unit of the second task is in a non-target region, in order to execute the second task, the first goods-carrying tool may move to the non-target region. In another possible implementation, by directly controlling the first goods-carrying tool to execute the second task, the first goods-carrying tool moves to the non-target region, thereby dispatching the first goods-carrying tool to the non-target region.

In this embodiment of the present disclosure, after the target region is determined, a goods-carrying tool in the target region is dispatched to a non-target region, so that the utilization of the goods-carrying tool is improved, and the warehousing efficiency is further improved.

Based on the embodiment shown in FIG. 4, further, in a possible implementation, as shown in FIG. 4, the method for controlling a warehousing system provided in this embodiment of the present disclosure may further include the following operations:

In block S302: a second goods-carrying tool in the warehousing system is controlled to be forbidden from entering the target region.

The second goods-carrying tool is a goods-carrying tool in another region other than the target region. An execution sequence of operation in block S302 is not limited between operation in block S301 in FIG. 4 and operation in block S102, and for example, may be executed after operation in block S101, executed after operation in block S102, or executed after operation in block S103, and the execution sequence shown in FIG. 4 is only used as an example for description in the embodiments of the present disclosure.

To further ensure the safety of the target region, in addition to dispatching the first goods-carrying tool in the target region to a non-target region or setting the state of the first goods-carrying tool to a non-operating state, a second goods-carrying tool in the non-target region may be also controlled to move in the non-target region. A specific implementation of controlling to forbid the second goods-carrying tool in the warehousing system from entering the target region is not limited in the embodiments of the present disclosure. For example, the second goods-carrying tool may be prevented from moving to the target region by setting a boundary between the target region and the non-target region to be non-crossing. In a possible implementation, the controlling to forbid a second goods-carrying tool in the warehousing system from entering the target region includes:
stopping a first task of the second goods-carrying tool; and/or stopping distributing the first task to the second goods-carrying tool, where a target shelving unit of the first task is in the target region.

The second goods-carrying tool may need to execute a plurality of tasks, where the plurality of tasks may include one or more first tasks and one or more second tasks. In a possible implementation, by stopping the first task of the second goods-carrying tool, the second goods-carrying tool may execute the second task according to a task sequence. Since the target shelving unit of the second task is in the non-target region, in order to execute the second task, the second goods-carrying tool may move to the non-target region. In another possible implementation, by stopping distributing the first task to the second goods-carrying tool, the second goods-carrying tool is controlled to perform goods storage and delivery in the non-target region. The embodiments of the present disclosure only use this manner as an example and are not limited thereto.

In this embodiment of the present disclosure, a goods-carrying tool in a non-target region is controlled to be forbidden from entering the target region, thereby further ensuring the safety of the target region.

Based on the embodiments shown in any one of FIG. 2 to FIG. 4, in a possible implementation, the guard door corresponds to a plurality of target regions, and FIG. 5 is a schematic flowchart of a method for controlling a warehousing system according to yet another embodiment of the present disclosure. As shown in FIG. 5, in the method for controlling a warehousing system provided in this embodiment of the present disclosure, after operation in block S101 of determining a target region corresponding to the guard door, the method may further include the following operations:

In block S401: location information of the user is obtained, and a target region corresponding to the location information is determined.

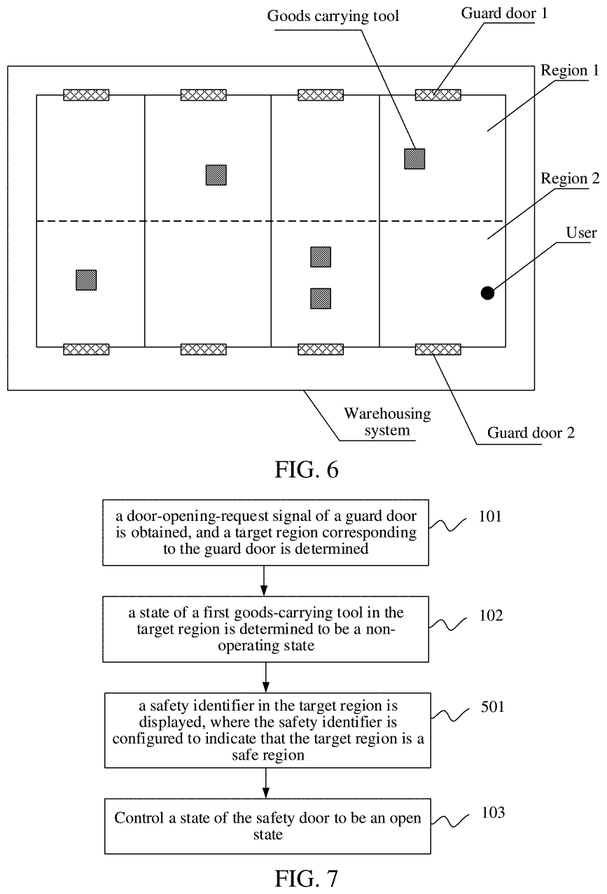

For ease of description, FIG. 6 is a schematic structural diagram of a warehousing system according to an embodiment of the present disclosure. As shown in FIG. 6, a warehousing area in the warehousing system includes a plurality of regions, where a guard door 1 corresponds a region 1, a guard door 2 corresponds to a region 2, and the regions may be isolated by a virtual wall. For example, the region 1 and the region 2 are isolated by a virtual wall (a dashed-line part), but the user may move between the region 1 and the region 2, for example, the user may enter the region 1 or the region 2 through the guard door 1 or the guard door 2.

In the application scenario shown in FIG. 6, the target region in which the user is located may be determined by detecting the location information of the user. A specific implementation of obtaining the location information of the user is not limited in the embodiments of the present disclosure. In a possible implementation, the obtaining location information of the user includes: detecting a tag of the user, where the tag has a positioning identification function; and parsing the tag to obtain the location information of the user.

When the user enters a guard door, the user may carry a tag by wearing a badge, a ribbon, or a sticker with the tag or wearing a vest or hat with the tag, which is not limited in the embodiments of the present disclosure. A specific type of the tag is not limited in the embodiments of the present disclosure. For example, the tag may be identified through radio frequency identification (RFID), ultra wideband (UWB) identification, two-dimensional code recognition, or image recognition, to determine the location information of the user.

In this embodiment of the present disclosure, the tag of the user is detected or parsed to determine the location information of the user, so that the accuracy of the location information of the user may be improved, and the tag of the user is detected and identified, so that the efficiency of obtaining the location information of the user may be further improved. In addition, compared with the related art of determining the location information of the user through infrared detection, costs for obtaining the location information of the user may be further reduced. In addition, each user may be distinguished by using a different tag, so that detecting tags of users is further conducive to subsequent management of the users.

As shown in FIG. 6, it is determined that the region in which the user is located is the region 2 through detection.

The corresponding operation in block S102 of determining that a state of a goods-carrying tool in the target region is a non-operating state may be implemented by performing operation in block S402.

In block S402: a state of a goods-carrying tool in the target region corresponding to the location information is determined to be a non-operating state.

After determining that the region in which the user is located is the region 2, the region 2 is determined as a target region, and a state of a goods-carrying tool in the region 2 is determined as a non-operating state. A manner for controlling the goods-carrying tool in the target region corresponding to the location information is not limited in the embodiments of the present disclosure, and for details, reference may be made to the manner for controlling the first goods-carrying tool in the target region in the foregoing embodiments, which is not described herein again in the embodiments of the present disclosure.

A region, for example, the region 1 in FIG. 6 other than the target region in which the user is located in the plurality of target regions may be used as a non-target region for processing, and for details, reference may be made to the control manner in a non-target region in the foregoing embodiments, which is not described herein again in the embodiments of the present disclosure.

In a possible implementation, when the guard door corresponds to a plurality of target regions, the plurality of target regions may have a plurality of guard doors. As shown in FIG. 6, the guard door 1 corresponds to the region 1 and the region 2, and the guard door 2 also corresponds to the region 1 and the region 2. If the user enters the region 1 or the region 2 through the guard door 1, the location information of the user may be detected to determine to close the guard door away from the user, and the guard door closest to the user may be also opened for the user to walk out the region. For example, a current location of the user is in the region 2, so that the guard door 1 is closed and the guard door 2 is opened. Alternatively, a user request is received to open a guard door that the user requests to open, which is not limited in the embodiments of the present disclosure.

In this embodiment of the present disclosure, when the guard door corresponds to a plurality of target regions, not only the safety of the target region in which the user is located is ensured, but also the flexibility of the goods-carrying tool and the operating efficiency of the goods-carrying tool may be further improved.

Based on any one of the foregoing embodiments, in a possible implementation, FIG. 7 is a schematic flowchart of a method for controlling a warehousing system according to yet another embodiment of the present disclosure. As shown in FIG. 7, in the method for controlling a warehousing system provided in this embodiment of the present disclosure, after operation in block S102 of determining that a state of a goods-carrying tool in the target region is a non-operating state, the method may further include:

In block S501: a safety identifier in the target region is displayed, where the safety identifier is configured to indicate that the target region is a safe region.

A location of the safety identifier is not limited in the embodiments of the present disclosure. In a possible implementation, the safety identifier may be set at a location of the guard door, or the safety identifier may be set near an illumination device, or the safety identifier may be arranged on a shelving unit, which is not limited in the embodiments of the present disclosure. For ease of viewing by the user, in a possible implementation, the safety identifier is a ground identifier.

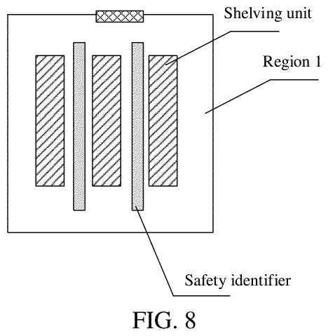

For ease of description, FIG. 8 is a schematic structural diagram of a target region according to an embodiment of the present disclosure. As shown in FIG. 8, for example, the target region being the region 1 is used as an example, the target region may include a plurality of shelving units, an aisle may exist between the shelving units, the user may move in the aisle, and the safety identifier may be set at a location of the aisle.

In a possible implementation, according to the method for controlling a warehousing system provided in this embodiment of the present disclosure, after the determining that a state of a goods-carrying tool in the target region is a non-operating state, the method further includes: sending second prompt information to the user, where the second prompt information is configured to prompt the user that the target region is a safe region.

A specific implementation of sending the second prompt information to the user is not limited in the embodiments of the present disclosure. For example, the user may be prompted that the target region is a safe region by transmitting a short message, a micro message, or an email, or pushing a message or a voice prompt to a terminal device of the user. The embodiments of the present disclosure only use this manner as an example and are not limited thereto.

The following is an apparatus embodiment of the present disclosure, which may be used to perform the method embodiments of the present disclosure. For details not disclosed in the apparatus embodiments of the present disclosure, reference may be made to the method embodiments of the present disclosure.

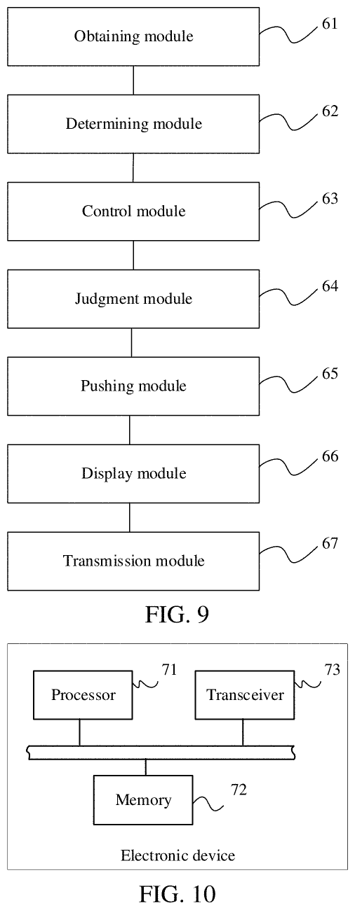

FIG. 9 is a schematic structural diagram of an apparatus for controlling a warehousing system according to an embodiment of the present disclosure. The apparatus may be implemented through software and/or hardware, and for example, may be implemented through a terminal device. As shown in FIG. 9, the apparatus for controlling a warehousing system provided in this embodiment of the present disclosure may include: an obtaining module 61, a determining module 62, and a control module 63.

The obtaining module 61 is configured to obtain a door-opening-request signal of a guard door, and determine a target region corresponding to the guard door, the target region being at least one region in a plurality of regions of the warehousing system. The determining module 62 is configured to determine that a state of a first goods-carrying tool in the target region is a non-operating stat. The control module 63 is configured to control a state of the guard door to be an open state.

In a possible implementation, according to the apparatus for controlling a warehousing system provided in this embodiment of the present disclosure, the determining module 62 is further configured to:
send an operation-stop instruction to the first goods-carrying tool, to cause the first goods-carrying tool to stop operation; and detect the state of the first goods-carrying tool, to determine that the state of the first goods-carrying tool is a non-operating state.

In a possible implementation, the apparatus for controlling a warehousing system provided in this embodiment of the present disclosure further includes:
a pushing module 65, configured to push first prompt information if the state of the first goods-carrying tool is an operating state, where the first prompt information is configured to prompt a user that the target region is a non-safe region.

In a possible implementation, the first goods-carrying tool is a robot or a forklift.

In a possible implementation, the control module 63 is specifically configured to:
start a first task of the first goods-carrying tool, and/or distribute the first task to the first goods-carrying tool, where a target shelving unit of the first task is in the target region.

The apparatus in this embodiment may execute the method embodiment shown in FIG. 2. The technical principles and technical effects thereof are similar to those of the foregoing embodiment, and details are not described herein again.

Based on the embodiment shown in FIG. 9, further, in another embodiment providing an apparatus for controlling a warehousing system of the present disclosure, the apparatus for controlling the warehousing system includes:
a judgment module 64, configured to determine whether the first goods-carrying tool exists.

The apparatus in this embodiment may execute the method embodiment shown in FIG. 3. The technical principles and technical effects thereof are similar to those of the foregoing embodiment, and details are not described herein again.

Based on the embodiment shown in FIG. 9, further, in another embodiment providing an apparatus for controlling a warehousing system of the present disclosure, the control module 63 is further configured to:
dispatch the first goods-carrying tool to another region other than the target region in the warehousing system.

In a possible implementation, the control module 63 is specifically configured to:
stop a first task of the first goods-carrying tool, a target shelving unit of the first task is in the target region, and/or control the first goods-carrying tool to execute a second task, a target shelving unit of the second task is in another region other than the target region in the warehousing system.

Based on the embodiment shown in FIG. 9, further, in another embodiment providing an apparatus for controlling a warehousing system of the present disclosure, the control module 63 is further configured to:
control to forbid a second goods-carrying tool in the warehousing system from entering the target region, where the second goods-carrying tool is a goods-carrying tool in another region other than the target region.

In a possible implementation, the control module 63 is specifically configured to:
stop a first task of the second goods-carrying tool; and/or stop distributing the first task to the second goods-carrying tool, where a target shelving unit of the first task is in the target region.

The apparatus in this embodiment may execute the method embodiment shown in FIG. 4. The technical principles and technical effects thereof are similar to those of the foregoing embodiment, and details are not described herein again.

Based on the embodiment shown in FIG. 9, further, in another embodiment providing an apparatus for controlling a warehousing system of the present disclosure, the obtaining module 61 is further configured to obtain location information of the user to determine a target region corresponding to the location information; and
the determining module 62 is specifically configured to determine that a state of a goods-carrying tool in the target region corresponding to the location information is a non-operating state.

In a possible implementation, the obtaining module 61 is specifically configured to:
detect a tag of the user, where the tag has a positioning identification function; and parse the tag to obtain the location information of the user.

The apparatus in this embodiment may execute the method embodiment shown in FIG. 5. The technical principles and technical effects thereof are similar to those of the foregoing embodiment, and details are not described herein again.

Based on the embodiment shown in FIG. 9, further, in another embodiment providing an apparatus for controlling a warehousing system of the present disclosure, the apparatus for controlling a warehousing system provided in this embodiment of the present disclosure further includes:
a display module 66, configured to display a safety identifier in the target region, where the safety identifier is configured to indicate that the target region is a safe region.

In a possible implementation, the safety identifier is a ground identifier.

In a possible implementation, the apparatus for controlling a warehousing system provided in this embodiment of the present disclosure further includes:
a transmission module 67, configured to send second prompt information to the user, where the second prompt information is configured to prompt the user that the target region is a safe region.

In a possible implementation, according to the apparatus for controlling a warehousing system provided in this embodiment of the present disclosure, the control module 63 is further configured to:
restore the state of the first goods-carrying tool to an operating state if the state of the guard door is determined as a closed state and/or no user is in the target region.

The apparatus in this embodiment may execute the method embodiment shown in FIG. 7. The technical principles and technical effects thereof are similar to those of the foregoing embodiment, and details are not described herein again.

The apparatus embodiments provided in the present disclosure are merely exemplary, the module division in FIG. 9 is merely logical function division, and there may be other division manners during actual implementation. For example, a plurality of modules may be combined or integrated into another system. Couplings between the modules may be implemented through some interfaces, the interfaces are generally electrical communication interfaces but do not exclude mechanical interfaces or interfaces in other forms. Therefore, the modules described as separate components may or may not be physically separated, that is, may be located in one place or may be distributed to the same location or different locations of different devices.

An embodiment of the present disclosure provides a warehousing system, the warehousing system includes a guard door and a goods-carrying tool, and reference may be made to the warehousing system shown in FIG. 1 or FIG. 6. The guard door may be configured to perform the method for controlling a warehousing system, and for details, reference may be made to the foregoing method embodiments. Content and effects thereof are not described herein again.

FIG. 10 is a schematic structural diagram of an electronic device according to an embodiment of the present disclosure. The electronic device may be a guard door, and as shown in FIG. 10, the electronic device includes:
a processor 71, a memory 72, a transceiver 73, and a computer program, where the transceiver 73 implements data transmission with other devices, the computer program is stored in the memory 72 and is configured to be executed by the processor 71, the computer program includes instructions used for performing the method for controlling a warehousing system, and for content and effects thereof, reference may be made to the foregoing method embodiments.

In addition, an embodiment of the present disclosure further provides a computer-readable storage medium, storing computer-executable instructions, the computer-executable instructions, when executed by at least one processor of user equipment, causing the user equipment to perform the foregoing various possible methods.

The computer-readable medium includes a computer storage medium and a communication medium, where the communication medium includes any medium that enables a computer program to be transmitted from one place to another. The storage medium may be any available medium accessible to a general-purpose or dedicated computer. For example, a storage medium is coupled to a processor, so that the processor can read information from the storage medium or write information into the storage medium. Certainly, the storage medium may be a component of the processor. The processor and the storage medium may be located in an application-specific integrated circuit (ASIC). In addition, the ASIC may be located in the user equipment. Certainly, the processor and the storage medium may be used as discrete assemblies existing in a communication device.

A person of ordinary skill in the art may understand that all or some of the steps of the method embodiments may be implemented by a program instructing relevant hardware. The program may be stored in a computer-readable storage medium. When the program is executed, steps of the foregoing method embodiments are performed. The foregoing storage medium includes: a medium such as a ROM, a RAM, a magnetic disk, or an optical disc that can store program code.

Finally, it should be noted that the foregoing embodiments are merely used for describing the technical solutions of the present disclosure, but are not intended to limit the present disclosure. Although the present disclosure is described in detail with reference to the foregoing embodiments, a person of ordinary skill in the art should understand that, modifications may still be made to the technical solutions in the foregoing embodiments, or equivalent replacements may be made to some or all of the technical features; and these modifications or replacements will not cause the essence of corresponding technical solutions to depart from the scope of the technical solutions in the embodiments of the present disclosure.

What is claimed is:

1. A method for controlling a warehousing system, comprising:
obtaining a door-opening-request signal of a first guard door, and determining a first target region corresponding to the first guard door, the first target region being at least one region in a plurality of regions of the warehousing system;
determining that a state of a first goods-carrying tool in the first target region is a non-operating state, or dispatching the first goods-carrying tool to another region other than the first target region in the warehousing system; and
controlling a state of the first guard door to be an open state.

2. The method according to claim 1, wherein the determining that a state of a first goods-carrying tool in the first target region is a non-operating state comprises:
sending an operation-stop instruction to the first goods-carrying tool, to cause the first goods-carrying tool to stop operation; and
detecting the state of the first goods-carrying tool, to determine that the state of the first goods-carrying tool is the non-operating state.

3. The method according to claim 2, wherein after the detecting the state of the first goods-carrying tool, the method further comprises:
pushing first prompt information when the state of the first goods-carrying tool is an operating state, wherein the first prompt information is configured to prompt a user that the first target region is a non-safe region.

4. The method according to claim 2, wherein before the determining that a state of a first goods-carrying tool in the first target region is a non-operating state, the method further comprises:
determining whether the first goods-carrying tool exists in the first target region; and
controlling the state of the first guard door to be an open state when determining that there is no first goods-carrying tool in the first target region.

5. The method according to claim 1, further comprising:
controlling to forbid a second goods-carrying tool in the warehousing system from entering the first target region, wherein the second goods-carrying tool is a goods-carrying tool in another region other than the first target region.

6. The method according to claim 1, wherein the first guard door corresponds to a plurality of target regions, and after the determining a first target region corresponding to the first guard door, the method further comprises:
obtaining location information of the user and determining a target region corresponding to the location information as a second target region; and
determining that a state of a goods-carrying tool in the second target region corresponding to the location information is a non-operating state.

7. The method according to claim 6, wherein the obtaining location information of the user comprises:
detecting a tag of the user, wherein the tag has a positioning identification function; and
parsing the tag to obtain the location information of the user.

8. The method according to claim 6, wherein after the obtaining location information of the user and determining a target region corresponding to the location information as a second target region, the method further comprises:
determining the first target region as a non-target region, wherein the second target region is different from the first target region.

9. The method according to claim 8, wherein the second target region corresponds to a second guard door;
after the determining the first target region as a non-target region, the method further comprises:
controlling, according to the location information, a state of a guard door, which is farther from the user in the first guard door and the second guard door, to be a closed state, and a state of a guard door closest to the user to be an open state.

10. The method according to claim 1, wherein after the determining that a state of a first goods-carrying tool in the first target region is a non-operating state, the method further comprises:
displaying a safety identifier in the first target region, wherein the safety identifier is configured to indicate that the first target region is a safe region.

11. The method according to claim 10, wherein
the safety identifier is a ground identifier.

12. The method according to claim 1, further comprising:
restoring the state of the first goods-carrying tool to an operating state if the state of the first guard door is determined as a closed state and/or no user is in the first target region.

13. The method according to claim 12, wherein the restoring the state of the first goods-carrying tool to an operating state comprises at least one of:
starting a first task of the first goods-carrying tool, or
distributing the first task to the first goods-carrying tool, wherein a target shelving unit of the first task is in the first target region.

14. An apparatus for controlling a warehousing system, comprising:
at least one processor, and
a memory communicatively connected to the at least one processor, wherein
the memory stores instructions executable by the at least one processor, and the instructions, when being executed by the at least one processor, are configured to perform operations of:
obtaining a door-opening-request signal of a first guard door, and determining a first target region corresponding to the first guard door, the first target region being at least one region in a plurality of regions of the warehousing system;
determining that a state of a first goods-carrying tool in the first target region is a non-operating state, or dispatching the first goods-carrying tool to another region other than the first target region in the warehousing system; and
controlling a state of the first guard door to be an open state.

15. The apparatus for controlling a warehousing system according to claim 14, wherein the first guard door corresponds to a plurality of target regions;
the instructions are further configured to perform operations of:
obtaining location information of the user and determining a target region corresponding to the location information as a second target region, wherein the second target region is different from the first target region, and the second target region corresponds to a second guard door; and
determining that a state of a goods-carrying tool in the second target region corresponding to the location information is a non-operating state.

16. The apparatus for controlling a warehousing system according to claim 15, wherein the instructions are further configured to perform operations of:
determining the first target region as a non-target region; and
controlling, according to the location information, a state of a guard door, which is farther from the user in the first guard door and the second guard door, to be a closed state, and a state of a guard door closest to the user to be an open state.

17. A warehousing system, comprising a goods-carrying tool, an apparatus for controlling the warehousing system, and a first guard door, wherein the apparatus for controlling the warehousing system is configured to perform operations of:
obtaining a door-opening-request signal of the first guard door, and determining a first target region corresponding to the first guard door, the first target region being at least one region in a plurality of regions of the warehousing system;
determining that a state of the goods-carrying tool in the first target region is a non-operating state, or dispatching the first goods-carrying tool to another region other than the first target region in the warehousing system; and
controlling a state of the first guard door to be an open state.

18. The warehousing system according to claim 17, further comprises a second guard door, wherein the apparatus for controlling the warehousing system is further configured to perform operations of:
obtaining location information of the user and determining a target region corresponding to the location information as a second target region, wherein the second target region is different from the first target region, and the second target region corresponds to the second guard door; and
determining that a state of a goods-carrying tool in the second target region corresponding to the location information is a non-operating state.

19. The warehousing system according to claim 18, wherein the apparatus for controlling the warehousing system is further configured to perform operations of:
determining the first target region as a non-target region; and
controlling, according to the location information, a state of a guard door, which is farther from the user in the first guard door and the second guard door, to be a closed state, and a state of a guard door closest to the user to be an open state.

20. A non-transitory computer-readable storage medium storing computer instructions, and the computer instructions, when being executed by a computer, are configured to perform operations of:
obtaining a door-opening-request signal of a first guard door, and determining a first target region corresponding to the first guard door, the first target region being at least one region in a plurality of regions of the warehousing system;
determining that a state of a first goods-carrying tool in the first target region is a non-operating state, or dispatching the first goods-carrying tool to another region other than the first target region in the warehousing system; and
controlling a state of the first guard door to be an open state.
